(19) United States
(12) Patent Application Publication
(10) Pub. No.: US 2005/0097797 A1
(43) Pub. Date: May 12, 2005

(54) DISPLAY SET

(76) Inventors: Chien-Jui Wang, Taipei City (TW); Hsien-Chun Chang, Tao-Yuan Hsien (TW); Chun-Hsiung Yin, Tainan Hsien (TW); Chia-Chuan Lin, Taipei Hsien (TW)

Correspondence Address: NORTH AMERICA INTERNATIONAL PATENT OFFICE (NAIPC), P.O. BOX 506, MERRIFIELD, VA, 22116, US

(21) Appl. No.: 10/904,339

(22) Filed: Nov. 4, 2004

(30) Foreign Application Priority Data
Nov. 7, 2003 (TW) 092131298

(51) Int. Cl. G09F 15/00

(52) U.S. Cl. 40/610

(57) ABSTRACT

A display set has a display panel, a first holder, a first hinge for rotatably fixing the first holder to a first side of the display panel, a second holder, and a second hinge for rotatably fixing the second holder to the first side of the display panel. The first holder is capable of rotating towards a first direction and the second holder is capable of rotating towards a second direction different from the first direction.

### BACKGROUND OF INVENTION

1. Field of the Invention

The present invention relates to a display set, and more particularly, to a display set having two rotatable holders.

2. Description of the Prior Art

Please refer to FIG. 1, which is a schematic diagram of a display set 10 according to the prior art. The display set 10 comprises a display panel 12, a base 14 and a hinge 16. The display panel 12 can be rotated around the base 14 by the hinge 16. The hinge 16 further fixes the display panel 12 to a central part of the base 14.

The base 14 can be rotated towards the display panel 12 for compact storage of the display set 10. Please refer to FIG. 2, which is a side view of the display set 10 when the base 14 is rotated towards the display panel 12 according to the prior art. When the base 14 is rotated towards the display panel 12, the base 14 can be equivalently divided into two parts, one protruding outside the display panel 12 (indicated by arrow A) and the other behind the display panel 12 (indicated by arrow B). The part of the base 14 behind the display panel 12 increases the bulk of a container for accommodating the display set 10.

Please refer to FIG. 3, which is a side view of the display set 10 ready to be carried when the base 14 has been rotated towards the display panel 12 according to the prior art. As shown in FIG. 3, the hinge 16 is located on a position deviated from a central line LL′, the display set 10 has an asymmetrical structure and the hinge 16 is vulnerable.

Please refer to FIG. 4, which is a schematic diagram of another display set 20 according to the prior art. The display set 20 also comprises a display panel 22, a base 24, and a hinge 26. Contrary to the hinge 16 fixing the display panel 12 to the central part of the display panel 12, the hinge 26 fixes the display panel 22 to a first side of the base 24.

Since the base 24 of the display set 20 does not have a back part like the part indicated by arrow A of the base 14 of the display set 10 shown in FIG. 2, the display set 20 can be accommodated into a container of a smaller bulk when the base 24 is rotated towards the display panel 22. However, lacking the back part makes the display set 20 difficult to carry when the base 24 is rotated towards the display panel 22 and makes the display set 20 prone to fall toward a direction indicated by arrow C when hit by an unexpected impact.

### SUMMARY OF INVENTION

Therefore, a primary objective of the invention is to provide a display set having characteristics of small bulk, stable structure, and easy to carry and to store.

According to the invention, the display set includes a display panel, a first holder for rotating towards a first direction, a first hinge for rotatably fixing the first holder to a first side of the display panel, a second holder for rotating towards a second direction different from the first direction, and a second hinge for rotatably fixing the second holder to the first side of the display panel.

Since the first and the second holders can be selectively unfolded to prop the display panel or folded to be carried or to be stored, the display set of the present invention has a small bulk, a durable structure, and is easy to carry and store.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a schematic diagram of a display set according to the prior art.

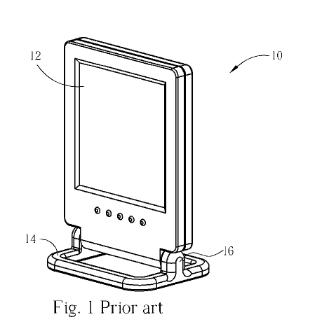

FIG. 2 is a side view of the display set shown in FIG. 1 according to the prior art.

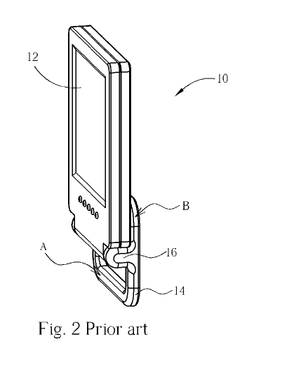

FIG. 3 is another side view of the display set shown in FIG. 1 according to the prior art.

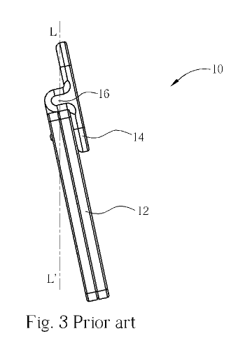

FIG. 4 is a schematic diagram of another display set according to the prior art.

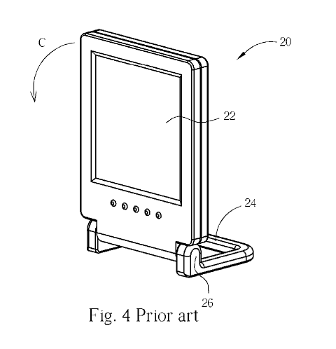

FIG. 5 is a schematic diagram of a display set of the preferred embodiment according to the present invention.

FIG. 6 is a schematic diagram of the display set shown in FIG. 5 when a first holder and a second holder are respectively rotated along a first and a second direction for compact storage according to the present invention.

FIG. 7 is a side view of the display set shown in FIG. 6 according to the present invention.

FIG. 8 is a cross sectional diagram along a line NN′ of a first hinge of the display set to illustrate the present invention.

FIG. 9 is a schematic diagram of a display set of a second embodiment according to the present invention.

FIG. 10 is a cross sectional diagram along a line PP′ of a hinge of the display set to illustrate the present invention.

### DETAILED DESCRIPTION

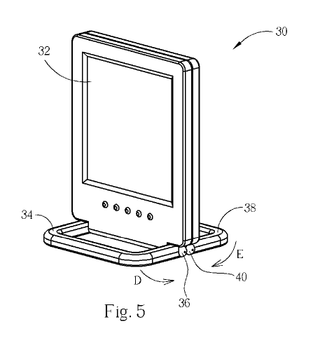

Please refer to FIG. 5, which is a schematic diagram of a display set 30 of the preferred embodiment according to the present invention. The display set 30 comprises a display panel 32, a first holder 34, a first hinge 36 for rotatably fixing the first holder 34 to a first side of the display panel 32, a second holder 38, and a second hinge 40 for rotatably fixing the second holder 38 to the first side of the display panel 32.

In the preferred embodiment, the first and the second holders 34 and 38 have a thickness sum smaller than that of the display panel 32, the display panel 32 is a liquid crystal display (LCD), the first holder 34 can be rotated towards a first direction D, and the second holder 38 can be rotated towards a second direction E opposite to the first direction D for compact storage. In other words, the first holder 34 and the second holder 38 rotate towards each other to form a first structure for compact storage, and the first holder 34 and the second holder 38 rotate separately to form a second structure for supporting the display panel 32. As shown in FIG. 5, the display set 30 is stable and hard to topple when the first and the second holders 34 and 38 are unfolded.

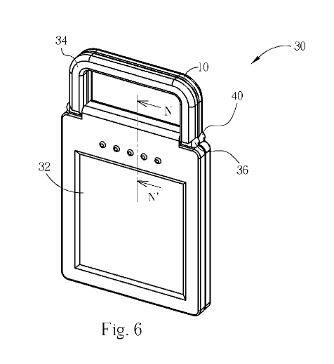

As described above, the first and the second holders 34 and 38 of the display set 30 can respectively rotate oppositely to the first direction D and the second direction E to spread out for propping the display panel 32. Please refer to FIG. 6, which is a schematic diagram of the display set 30 when the first and the second holders 34 and 38 are respectively rotated along the first and the second directions D and E for compact storage according to the present invention. As shown in FIG. 6, the first holder 34 and the second holder 38 altogether are equivalently equal to the part indicated by arrow A of the base 14 of the display set 10, so the display set 30 can be carried easily when the first and the second holders 34 and 38 are respectively rotated along the first and the second directions D and E and restored to a position close to the first side of display panel 32.

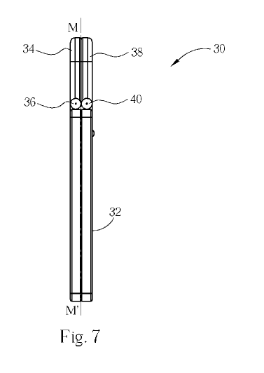

Please refer to FIG. 7, which is a side view of the display set 30 when the first and the second holders 34 and 38 are restored to the position close to the first side of the display panel 32 according to the present invention. FIG. 7 shows that the first holder 34 and the first hinge 36 are located on the left to a central line MM′ and the second holder 38 and the second hinge 40 are located on the right to the central line MM′ evenly, which forms a symmetric structure. So the first and the second hinges 36 and 40 are durable and not easily damaged when the display set 30 is carried.

In the preferred embodiment, both the first and the second holders 34 and 38 have a shape of ring. Of course, a first and a second holders of a display set of the present invention can have a shape of a variety of geometric forms as long as the first and the second holders have a space large enough for a hand to carry when restored to the position close to the first side of a display panel of the display set.

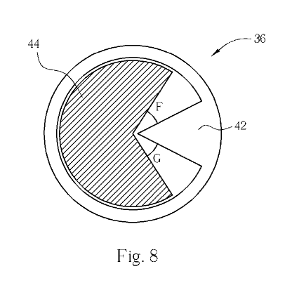

Please refer to FIG. 8, which is a cross sectional diagram along line NN′ of the first hinge 36 (and same for the second hinge 40) according to the present invention. The first hinge 36 comprises a first structure 42 connected to the first side of the display panel 32, and a second structure 44 connected to the first holder 34. The first and the second structures 42 and 44 have in between two included angles F and G. Of course, the first structure 42 can alternatively be connected to the first holder 34 and the second structure 44 can be connected to the first side of the display panel 32 accordingly.

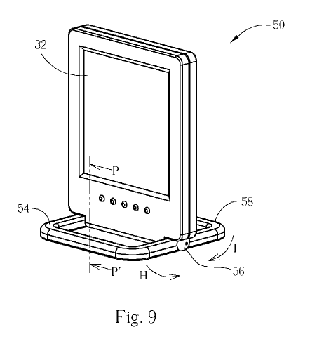

The display set 30 shown in FIG. 5 to FIG. 7 comprises two hinges, the first hinge 36 and the second hinge 40, for driving the first and the second holders 34 and 38 to rotate respectively. A display set of the present invention can comprise only one hinge. Please refer to FIG. 9, which is a schematic diagram of a display set 50 of a second embodiment according to the present invention. The display set 50 comprises the display panel 32, a first holder 54 capable of rotating towards a third direction H, a second holder 58 capable of rotating towards a fourth direction I opposite to the third direction H, and a hinge 56 for rotatably fixing both of the first and the second holders 54 and 58 to the first side of the display panel 32. The first and the second holders 54 and 58 also have a thickness sum smaller than or equal to that of the display panel 32. As shown in FIG. 9, the display set 50 is stable and hard to topple when the first and the second holders 54 and 58 are unfolded.

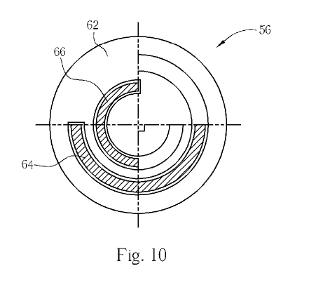

The first and the second holders 54 and 58 of the display set 50 also can be rotated respectively around the third and the fourth directions H and I and restored to a position close to the first side of the display panel 32 for compact storage. Please refer to FIG. 10, which is a cross sectional diagram along a line PP′ of the hinge 56 of the display set 50 according to the present invention. The hinge 56 comprises a first structure 62 connected to the first side of the display panel 32, a second structure 64 and a third structure 66 respectively connected to the first holder 54 and to the second holder 58.

In contrast to the prior art, the present invention can provide a display set having a display panel, a first holder, a second holder, and a hinge fixing the first and the second holders to a first side of the display panel (or two hinges respectively fixing the first and second holders to the display panel). Since the first and the second holders can be respectively rotated to spread out and prop the display panel, the display set is hard to topple. Additionally, when the first and the second holders are restored to a position close to the first side of the display panel, the display set can be carried easily without possibly damaging the hinge. Lastly, since the first and the second holders have a thickness sum smaller than that of the display panel, the display set can be stored easily without the need of large accommodating capacity when the first and the second holders are restored to the position close to the side of the display panel.

Those skilled in the art will readily observe that numerous modifications and alterations of the device and method may be made while retaining the teachings of the invention. Accordingly, the above disclosure should be construed as limited only by the metes and bounds of the appended claims.

1. A display set comprising:
a display panel;
a first holder rotatably connecting to a first side of the display panel; and
a second holder rotatably connecting to the first side of the display panel;
wherein the first holder and the second holder rotate towards each other to form a first structure for compact storage, and rotate separately to form a second structure for supporting the display panel.

2. The display set of claim 1, further comprising a hinge for rotatably fixing the first holder and the second holder to the first side of the display panel.

3. The display set of claim 1, wherein the first holder and the second holder respectively rotate towards a first direction and a second direction to form the first structure, and respectively rotate against the first direction and the second direction to form the second structure.

4. The display set of claim 3, wherein the first direction is opposite to the second direction.

5. The display set of claim 1, wherein the first holder or the second holder has a space for hand carry.

6. The display set of claim 5, wherein the first holder or the second holder has a shape of ring.

7. A display set comprising:
a display panel;
a first holder for rotating along a first direction;
a second holder for rotating along a second direction different from the first direction; and
a hinge for rotatably fixing the first and second holders to a first side of the display panel.

8. The display set of claim 7, wherein the first direction is opposite to the second direction.

9. The display set of claim 7, wherein a thickness sum of the first holder and the second holder is smaller than or equal to that of the display panel.

10. The display set of claim 7, wherein the first holder has a shape of ring.

11. A display set comprising:
a display panel;
a first holder for rotating around a first direction;
a first hinge for rotatably fixing the first holder to a first side of the display panel;
a second holder for rotating around a second direction different from the first direction; and
a second hinge for rotatably fixing the second holder to the first side of the display panel.

12. The display set of claim 11, wherein the first direction is opposite to the second direction.

13. The display set of claim 11, wherein the first holder and the second holder have a thickness sum smaller than or equal to that of the display panel.

14. The display set of claim 11, wherein the first holder has a shape of ring.

15. The display set of claim 11, wherein the display panel is a liquid crystal display (LCD) panel.
